(19) United States
(12) Patent Application Publication
(10) Pub. No.: US 2026/0066590 A1
(43) Pub. Date: Mar. 5, 2026

(54) Intelligent Connector

(71) Applicant: Brett Thomas, Anaheim, CA (US)

(72) Inventor: Brett Thomas, Anaheim, CA (US)

(21) Appl. No.: 19/292,363

(22) Filed: Aug. 6, 2025

Related U.S. Application Data
(60) Provisional application No. 63/679,753, filed on Aug. 6, 2024.
(60) Provisional application No. 63/720,299, filed on Nov. 14, 2024.

(51) Int. Cl. H01R 13/66; H01R 13/02; H01R 13/52; H01R 13/58; H01R 13/717

(52) U.S. Cl. CPC H01R 13/6666; H01R 13/025; H01R 13/5208; H01R 13/5804; H01R 13/6658; H01R 13/6683; H01R 13/7175

(57) ABSTRACT

A non-sacrificial surge protector is able to reset without requiring replacement of a protective circuit element. The surge protector may be used to supply power to vehicles, e.g., recreational vehicles in a campground. In addition to power the surge protector may also provide communication capabilities. For example, the surge protector may include a WiFi device and/or an Ethernet over powerline circuit.

### CROSS-REFERENCE TO RELATED APPLICATIONS

This application claims benefit of and priority to U.S. provisional patent application Ser. No. 63/679,753, filed Aug. 6, 2024; U.S. provisional patent application Ser. No. 63/720,299 filed Nov. 14, 2024; and U.S. provisional patent application Ser. No. 63/858,751 filed Aug. 6, 2025, the disclosures of which are hereby incorporated herein by reference.

### FIELD OF THE INVENTION

The invention is in the field of electronics, and in particular in the field of surge protectors for vehicles.

### RELATED ART

Vehicles, such as recreational vehicles, may be connected to external power sources. For example, it is common for a campground to supply AC power campers. The connection between the campground and a vehicle may be protected by and surge protector.

### SUMMARY

A non-sacrificial surge protector is able to reset without requiring replacement of a protective circuit element. The surge protector may be used to supply power to vehicles, e.g., recreational vehicles in a campground. In addition to power the surge protector may also provide communication capabilities. For example, the surge protector may include a WiFi device and/or an Ethernet over powerline circuit.

An original or replacement powerline connector includes one or more sensors and an input/output configured to communicate digital representations of sensor outputs to a computing device. The computing device may be internal to the connector, and display data on the end/connector itself using, for example, LED display lights, and/or an LCD display. The computing device may include, for example, a smartphone, tablet computer, vehicle computer, a remote server, and/or computer managed by a campground. The computing device receives wireless communication from the replacement connector with alerts representing faults or issues, data of voltage, watts, amps, heat, frequency, inductance, impedance and so on. The computing device may be associated with a website or cloud service that receives the data and input from the replacement end via WiFi or other wireless technology. A version of the computing device optionally includes be a wireless remote display, such as it will display in real time the data, faults, alerts, etc. from the end/connector. The replacement powerline “connector” can be any of these but not limited to a polarized plug, a grounded plug, a plug end, a hospital grade plug, a twist lock plug, a NEMA plug, a heavy-duty plug, a power plug, replacement plug, or male plug in any variation of amperage or voltage rating. In addition, the powerline connector, may be disposed in a female end plug version as well such as a replacement socket, female connector, receptacle, power socket, electrical outlet, twist lock socket, hospital grade receptacle, IEC socket, and a socket outlet in any variation of amperage or voltage rating. The “connector” may be disposed at either end as a plug or between ends of a powerline as a pod.

In some examples a connector has sensors to detect heat, reversed polarity, wiring conditions, and even high/low voltage, but if a ‘fault’ is detected, it may be configured to sound an alarm (buzzer) or illuminate a light on the end/device itself. The ‘wireless may be independent as much as possible as an option.).

Various embodiments include a powerline sensing system comprising: a replacement plug configured to be attached to a power cable, the replacement plug comprising: a first sensor configured to generate a first analog output, an analog-to-digital converter configured to generate a digital representation of the first analog output, and an input/output configured to communicate the digital representation to a computing device. The powerline sensing system optionally further includes the computing device, wherein the computing device is configured to convey a status of the replacement plug to a user based on the digital representation.

Various embodiments a surge protector comprising: a voltage input configured to be connected to an AC or DC power source and to receive an input voltage from the power source; a voltage output configured to be connected to a vehicle and to provide an output voltage to the vehicle; a voltage surge protection circuit configured to prevent voltages above a desired threshold from appearing at the voltage output, the voltage surge protection circuit being non-sacrificial; and a reset circuit configured two reset the voltage surge protection circuit following appearance of a voltage above the desired threshold at the voltage input.

Various embodiments a connection system for providing both AC power outlets and internet connections, the system comprising: an AC power input configured to receive AC power from a power source; a first AC power output; a second AC power output, the first AC power output and the second AC power output each separately including a filter configured to prevent output voltages above a desired voltage; electrical connectors configured to convey the AC power between the AC power input and the first and second AC power outputs; an internet connector configured to establish external internet connections from the connection system to the internet; a first local internet connector configured to provide a first internet connection (access point) via the external internet connector, wherein the first local internet connector is co-located with the first AC power output; a second local internet connector configured to provide a second internet connection via the external internet connector, wherein the second local internet connector is co-located with the second AC power output; and control logic configured to configure the first and second local internet connectors; wherein the first and second AC power outputs are members of a set of at least 6 power outputs, each of the 6 power outputs being co-located with a separate local internet connector.

### BRIEF DESCRIPTION OF THE DRAWINGS

FIG. 1 illustrates a prior art replacement of a damaged connector, according to various embodiments of the invention.

FIG. 2 illustrates an intelligent connector, according to various embodiments of the invention.

FIG. 3 illustrates an intelligent connector disposed mid-line in a power cable, also referred to as a “pod”, according to various embodiments.

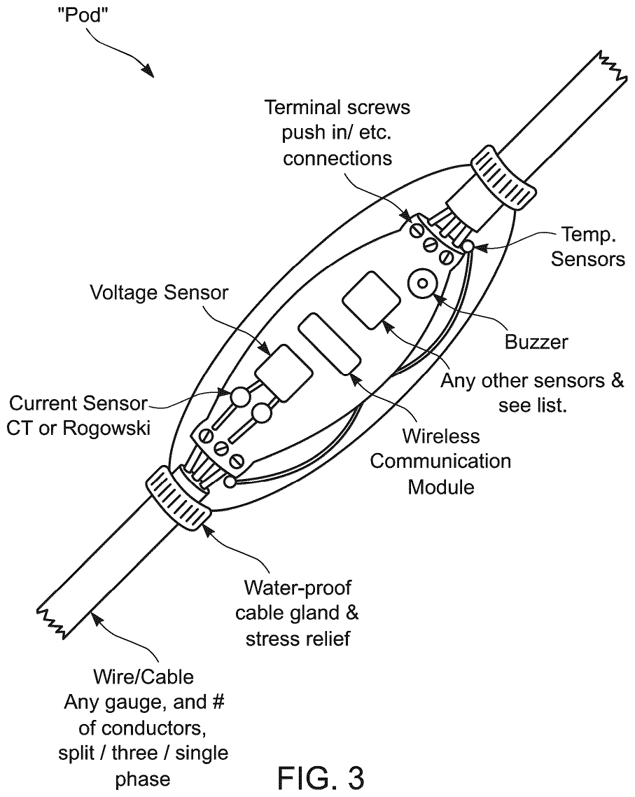

FIG. 4 illustrates various connectors providing alerts, according to various embodiments of the invention.

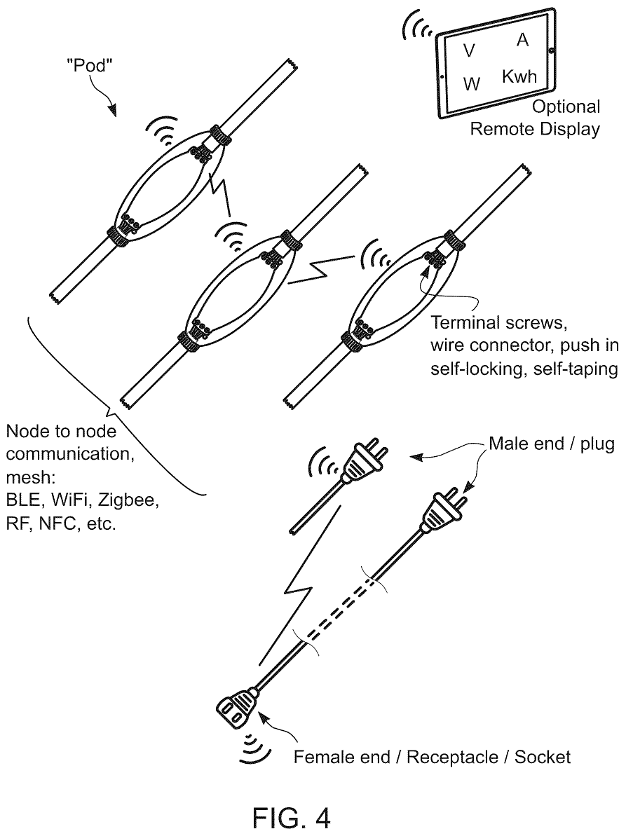

### DETAILED DESCRIPTION

Various embodiments of the invention include a connection system for providing both AC power outlets and internet connections. The connection system typically includes an AC power input configured to receive AC power from a power source. The Power source may be, for example, a central power panel for a campground, charging station or other parking area. the power source includes an AC power main or a DC to AC invertor. The Connection system further includes a first AC power output and a second AC power output. The first AC power output and the second AC power output each separately including a filter configured to prevent output voltages above a desired voltage, e.g., a surge protector. The surge protector may be non sacrificial or sacrificial. If non-sacrificial, the surge protector typically includes a “reset” mechanism, e.g., a reset button. The connection system further includes electrical connectors configured to convey the AC power between the AC power input and the first and second AC power outputs; and an internet connector configured to establish external internet connections from the connection system to the internet. The internet connector may be wireless (e.g., WiFi) or may be wired (e.g., an Ethernet connector). The external internet connections can be wired or wireless, e.g., satellite based. Typically, the external internet connections may be shared by a plurality of connector systems. For example, the external internet connection may be shared by multiple vehicles at a campground or parking area.

The connection system optionally further includes a first and second local internet connectors. In some embodiments the connection system includes at least 3, 4, 8 or 16 local internet connectors. Each of the local internet connectors is configured to provide an internet connection to a specific vehicle or set of vehicles. For example, a first local internet connection may be configured to provide an internet connection to an RV (or other type of vehicle) parked at a first location and a second local internet connection may be configured to provide an internet connection to an RV (or other type of vehicle) parked at a second location. Optionally, each internet connection is private and secure with respect to the others. Thus, each RV has its own private connection to the external internet. Specifically, the first local internet connection may be configured to provide a first internet connection (access point) via the external internet connector, wherein the first local internet connector is co-located with the first AC power output, and a second local internet connector may be configured to provide a second internet connection via the external internet connector, wherein the second local internet connector is co-located with the second AC power output. The local internet connectors may be wired or wireless.

The connection system optionally further includes control logic configured to configure the first and second local internet connectors. The control logic may be configured for establishing a local VPN for each RV parking space, for requiring that each RV parking provide a unique password, for requiring that an account be established and/or a payment be made for each internet connection provided, etc. Optionally, the control logic is managed via a manager interface. For example, via an interface accessed by a manager of a campground.

These embodiments optionally include a hardwired (connected) Wifi/internet “sender” down the powerline to a portable RV surge protector, OR stand-alone device, that decodes and encodes the signal (with some form of encryption or authentication). The “sender” unit is hardwired to an external WiFi/internet source, modem, cable, router, etc. Another method would be the “sender” is wireless where it just needs to be connected to the power lines for power and communication to downstream units, but it gets its WiFi/internet wirelessly. Sensors within the power connector may be configured to communicate data over the internet connection.

“Sender units” can be hardwired or wireless to get their WiFi/internet, receiver units can be the RV surge protector, or a stand-alone device that plugs into any AC outlet that is connected to the main power line with data. The receiver units (at RV) or stand-alone units (any AC outlet, or even built into the AC outlet) can act as hardwired internet/WiFi access points (for example with CAT5 port), and/or act as wireless access points.

In some embodiments the connection system includes at least 1, 2, 3, 6 or 14 additional local internet connectors, and/or at least 1, 2, 3, 6 or 14 additional AC power outputs, the additional local internet connectors each being co-located with one of the additional AC power outputs.

In some embodiments the local internet connectors each separately includes an Ethernet connector, a WiFi, Bluetooth or other wireless internet connection, such as Zigbee, IEEE 802.11Ah, Z-wave. The “sender” unit can be hardwired into a WiFi/internet source, or get data via other wireless methods (WiFi itself, or via SIM card and cell service to a cell provider). Receiver units may have ports and SIM card slots themselves and thus also act as “sender” units.

Optionally, at least one of the local internet connectors is configured to communicate digital data over the electrical connectors.

Optionally, the control logic is configured to associate each of the local internet connectors with different locations, different vehicle parking spaces, wherein the control logic is configured to assign different passwords to each of the local internet connectors. The control logic may be configured to automatically generate different passwords and/or network names for each of the local internet connectors. These internet connectors may be at different rooms, different apartments, different parking spaces, different campsites, and/or different IoT devices.

Optionally, if the ‘power line adapter’ system is integrated into the power pedestal itself, park operators have a way to provide internet, and control it, turn it on, off, etc. Park operators can thus also gain information on that particular RVer/tenant; how much power they have consumed, their amp draw, voltage, and so on. This information could be provided back to the park via the hardwired power line, or WiFi/internet through the system.

Optionally, each local internet connection is part of a mesh node, e.g., a WiFi or Bluetooth mesh node. Each mesh node may be encrypted even if they are connected to the same internet source. The WiFi/internet coming out of the units would be secure. The data on the power line would be encrypted/scrambled.

In some embodiments, the control logic is configured to assign different virtual private networks to each of the local internet connectors. Such assignment may be controlled by a management interface. For example, the manager of an RV park or campground may assign a different VPN to each of a plurality of RV parking spaces. Thus, the control logic is configured to configure the local internet connectors such that each is on a separate local network. The manager may use the control logic to turn on and off each of the local internet connections, optionally in response to payment of a fee. Optionally, the control logic is configured to reset each of the filters, is configured to reset each of the filters, and/or is configured to determine a status of each of the filters, e.g., the surge protection filters.

In embodiments in which the system is built into the pedestals of an RV park, or as stand-alone units, or even as the RV surge protector, real time data can be transmitted to the RV owner and/or the park owner. It could be faults detected, power use, surge events, similar to other devices out there that measure and monitor power, with a connected device a user would be able to see what devices are on at that time (AC unit on, microwave on for 2 mins, AC unit drawing higher amps than normal), etc. With an RV surge protector unit with a contactor, a user can schedule power on and off, remotely turn it on or off, etc. If the contactor is hardwired into the pedestal, you can have control at the source as well.

In some embodiments, each of the AC power outputs further include a power sensor configured to measure an amount of power drawn from each of the AC power outputs, wherein the control logic is optionally configured to receive the measured amounts of power. In some embodiments, each of the AC power outputs further include one or more voltage sensors configured to detect a floating ground, wherein the control logic is configured to turn off power to one or more of the AC power outputs associated with the floating ground.

Optionally, the RV surge protector can determine the status of the ground in the circuit. Typically, noncontact voltage sensors require you to hold them, you are the ground reference and then the non-contact voltage sensor will work. My idea is to have a sensor placed on metal points/body of the RV that would most likely result in HOT SKIN, if there was an issue. The remote sensors, communicate with the RV surge protector (at pedestal) to have a reference ground point. If this works, they can potentially detect hot skin with a permanently attached (but relocatable) sensor.

Optionally, the first local internet connection is configured to support more than one internet connection. For example, the first local internet connection can allow an Ethernet connection to a vehicle and a plurality of WiFi connections to user's smartphones.

In some embodiments, the RV surge protector, or stand-alone device acts as a ‘hot spot’ for internet/WiFi. The unit gets power from the AC line/pedestal, then is a hot spot. Option to have an internal SIM card for WiFi/internet if power line internet is not there. Output port for internet (out) built into the unit. May or may not be passed through the filter, etc like home surge protectors have a port for in/out data.

Ways to encrypt the data—the ‘sender’ unit can be set up as open, like an unprotected WiFi source. Or the sender can be closed/protected. When you plug into the AC power, you can see an internet source, but your unit cannot ‘decode’ it or communicate until it is ‘white listed’ or allowed by the Sender unit (RV park controls, etc.). “Nodes” or RV surge protector, or stand-alone units are ‘pre cleared’, set up by the park, and they ‘rent’ these out for wired/wireless internet access.

The RV surge protector or standalone devices optionally connect to available WiFi/internet and then transmit data ‘to the cloud’ and a user would just need an app to view said data—voltage, faults, amperage, Kilowatt Hours, Devices running, history of faults, and so on. Similar to ‘smart plugs’. You connect them to WiFi and as long as you have cell service on your phone/device you can control them.

The RV surge protector is optionally configured to generate an audible beep or sound (via a speaker) if/when surge event occurs. If unit is sacrificial, beep if/when the surge module is used up.

The Surge protector or standalone units can then be the ‘hub’ and allow access to control other sensors, and smart outlets (on/off). The surge protector can communicate in BLE (Bluetooth) or WiFi HaLow, etc. Will work with voice control—Alexa, Google Assistant, and so on. “Turn power on/off”, “what is my voltage” ?

Other unique features:
Port or connection point to add a grounding rod connected to the RV surge protector. This would be good for extra lightning protection by providing a better path to ground.
SIM card slot to add internet/connectivity
Power line broadband (internet) ability.
Surge protectors that communicate with each other like a mesh network.
Ability to connect to other devices and display the data or send data via power line. IE—you have a hot skin detector on the RV and it sends the data to the unit for alert, etc. You have a hand held multimeter without a display, but the data is shown on your phone/app.
Any surge protector that has a ‘hot swap’ type connection/conductor.
Any surge protector that has a built in adapter (at least on female end).
Optional, unique female output, with both 30 A and 50 A connections.

Various embodiments include a hot swap cord end. A common problem with RV surge protectors (and cords in general) is that the end becomes melted. The end can be the male end or the female end of either the RV surge protector, or the RV shore cable, etc. This is usually caused by a loose connection, over current, dirty/oxidized/pitted conductor, bent conductor, etc. It is not caused by surges and spikes (they happen too fast). However, once a male or female end becomes damaged, it is not safe to use and needs to be replaced. If there is corrosion, pitting, arching, etc the connection point becomes a point of high resistance and typically it will get hot at that point. As it gets hotter during electrical use, it becomes more resistive, and becomes even hotter. This can result in a thermal runaway, and cause melted ends or a fire. The ‘hot swap’ idea is a different way to replace the ends of a melted cord. There are existing replacement ends, but most do not include the cable/conductors. The novel idea I have is like a ‘guitar’ or ‘audio’ style plug. There are areas on the plug that are wired to the different wires (hot, neutral, ground, etc). The whole end is then one piece from the plug end to the male or female end. If it fails, or becomes damaged, you can replace the whole part. This design may (would have to test it) offer better protection from melted ends as there is more surface area and metal to metal contact. Also, during replacement, it would be as simple as unscrewing the old/damaged part and screwing in a new one, versus cutting wire, stripping wire jackets, torquing set screws, making sure it is wired correctly, etc. Another benefit of this idea, is that on the male or female ends, a user can have a ‘dog bone’ or power adapter built in. For example, the body of the RV surge protector is either a 30 A or 50 A unit, which you would want to match to your RV. The internals are rated for 30 A or 50 A, etc. However, if you are at an RV park that only has a 30 A connection, you can swap out the male and female cords/ends for 30 A and thus would not need to use an additional adapter. (let me know if this makes sense or you need more clarification). This is unique. Currently surge protectors are made one way (30 A or 50 A) and require the use of adapters. The more connection points, the higher the risk of failure/issues. The longer the cord is which is voltage loss, and it might not plug into the pedestal correctly. So this hot swap idea addresses several issues.

There is another way to do this with a special type male/female end that has the wires pre-stripped and it is molded in a special way that you just insert the wire ends into a terminal block and tighten them down for swapping/replacement, (see previous image sent).

Various embodiments include a built 110 AC outlet(s) (or DC/USB ports) on the surge protector. I have not seen an RV surge protector have a built in 110/120 household outlet on it. This would have to be tapped off of one of the hot legs, but it would add a benefit that allows you to connect ‘regular’ devices and plugs into the surge protector. Many pedestals DO NOT have a 110 outlet on them, so this would serve that purpose, plus provide surge protection, etc. (optionally on the body of the unit, or molded into the female/output end of the plug.)

Along these lines (mentioned before/elsewhere) you can have optional ports for coaxial cable, TV cable, phone lines, internet cable, etc. built into the unit, similar to how they are on household surge protectors, but this is novel for RV surge protectors.

Built in through display on unit, or through app or wireless communication is a surge counter. This might be patented to the Taiwan company, but no one has this function on RV surge protectors. I am not sure if it is patented or not, plus there maybe other ways to do it.

Other optional features that are not entirely novel (on other products, etc.);
Act as a hub for other sensors, where they send the data to the RV surge protector, which is connected to the internet via power line, etc., which then sends it to the cloud/user. Currently, our Power Watchdog unit, sends its data TO an external hub (RV WHISPER monitor station), which can link with multiple sensors—grey, black, electrical, propane, etc.
Remote power on/off for shore power, and scheduling feature.
There are home monitoring products out there (SENSE, etc.) that you plug into the house's main panel and by algorithms and programming, it can determine what load or appliance is on. There are no RV surge protectors that currently do this. The benefit is that you can possibly lower energy costs, knowing when things are on or off, possibly as a diagnostic tool on appliance health (compressor using more amps, etc.).

The AC outputs optionally include GFCI. (open ground) elevated ground current detection.

Some embodiments include a built in thermistors or temperature sensors that will illuminate a light on the front indicating heat is detected. The system can include an RV surge protector with an audible tone/siren speaker, with or without light/illumination, to indicate detection of heat above a safe level (precluding melting or fire of/on the unit). This can be tied into the alert features of the surge protector, alerting the owner of heat/fire. A warning may be communicated via internet connection to an app, a manager, and/or a smartphone of a suer. This audible alert is a safety benefit to the RV occupants, to the RV park and neighboring RVs if there is a danger of fire. (there are units that illuminate a small light for ‘over heating’ issues.

Some embodiments include a non-sacrificial surge protector uses capacitors, coils, and chokes, these are also the same parts used for making a ‘soft start’ device. This is typically a capacitor device that lowers inrush current on inductive loads (AC units, motors, etc.), which is better for the appliance, and also helps prevent over current draw. It can be possible to use the design itself with these parts to incorporate both a non-sacrificial surge effect, as well as a soft start effect.

In a side application that is associated with these parts, the surge protector can be able to correct or better the power factor of the electrical system.

Some embodiments include power factor correction. Power factor correction (PFC) is a technique that can improve a system's functionality while reducing the amount of reactive power it requires. PFC can be achieved by adding capacitors in parallel with the lighting circuits or motor that's connected. This can be done at the equipment, distribution board, or at the start of the installation.

Another option for the surge protector is the inclusion of a satellite receiver/module. Most current units only have Bluetooth, and some have WiFi. But with satellite, you only need a decently clear shot at the sky. Data packets for issues (faults) are low data, so this might not be the real time data, but only in emergencies (faults detected, too hot/melt detection, etc.) would be transmitted via Satellite.

The external internet connection optionally includes a satellite also as the source/mode for internet. So satellites would provide the internet, the surge protector would be the WiFi router/hub.

Another optional feature is to have a surge protector unit with a port or connection point on the unit, most likely on the top or side, where a user could attach a light, the surge protector could be on an extending pole apparatus, to illuminate the area around a campsite/power pedestal. Often, there is an issue of not having enough light. This can feed off power from the pedestal through the surge protector. The light is optionally controlled with a switch, and/or the app/wireless connection to the surge protector.

Another optional feature can be a port or connection point for a grounding rod. As mentioned, this would increase the protection from lightning coming from the RV park power side. If lightning strikes ‘upstream’ from your RV, it can flow through the power lines that are feeding your RV. Ground is not bonded to neutral in RVs (per code), only at the main transformer for the RV park. Adding a grounding rod at the pedestal via attachment to the surge protector, you are giving lightning a path to ‘earth ground’. It has a high probability of saving or help protecting your RV.

Another option for the surge protector is the inclusion of a satellite receiver/module. Most current units only have Bluetooth, and some have WiFi. But with satellite, you only need a decently clear shot at the sky. Data packets for issues (faults) are low data, so this might not be the real time data, but only in emergencies (faults detected, too hot/melt detection, etc.) would be transmitted via Satellite.

Some embodiments include a surge protector unit with a port or connection point on the unit, most likely on the top or side, where a light can be attached, the surge protector is optionally an extending pole apparatus, to illuminate the area around your campsite/power pedestal. Often, there is an issue of not having enough light. This would feed off power from the pedestal through the surge protector. The light can be controlled with a switch, and/or the app/wireless connection to the surge protector.

Another optional feature would be a port or connection point for a grounding rod. As mentioned, this would increase the protection from lightning coming from the RV park power side. If lightning strikes ‘upstream’ from your RV, it can flow through the power lines that are feeding your RV. Ground is not bonded to neutral in RVs (per code), only at the main transformer for the RV park. Adding a grounding rod at the pedestal via attachment to the surge protector, you are giving lightning a path to ‘earth ground’. It has a high probability of saving or help protecting your RV.

It is common that the plugs on power cords need to be replaced. Existing RV or other OEM power cords offer no other benefit other than conducting power from point A to point B. RV's have more electronics, homes have more electronics, industry has more sensitive electronics and equipment, that require/necessitate the need to make sure your power is good. So even if the plug is NOT damaged, this would be a safety ‘upgrade’ for the user. There are hundreds of thousands of RVs out there, where the customer does not want to buy a new surge protector or other device (that may or may not have these smart sensor features), so with this new device, they can make their existing RV shore cable ‘smart’, if they have a ‘dumb’ RV surge protector, they still have male/female ends, so this component would be a compliment to their existing set up which then makes it ‘smart’. For industry, hospitals, warehouses, there are millions of power cords, data lines and the like that can now be ‘smart’ and ‘in the know’ and aware of power issues, data use, wiring issues, faults, and/or just log general information.

One embodiment of the device is to use the intelligent connector as a diagnostic tool. All appliances that are on use power and draw amps (current). With granular detail of the power use, amps, inrush current, power factor, you can then determine the ‘health’ of the appliance. For example, you have an AC unit that draws 13 amps at 120 V AC, however, over time, the device/app can log and ‘sense’ that this AC unit is not drawing 14 amps at 120V AC, it means it is working harder for some reason. Possibly the filter needs cleaned, something is obstructing a moving part, or it is failing in another area. But the PlugIN device would have this ability to be used as a preventative diagnostic tool, analyzing incoming voltage, amp draw/use, inrush currents, power factor and other parameters as an added benefit or tool.

The need to replace connectors at the end of power cords is particularly true of power cords used to power recreational vehicles (RVs). Either male or female plugs may need to be replaced and replacement plugs may be used in applications other than powering RVs. The replacement plugs may include a variety of connector configurations, e.g., standard connectors for 10, 15, 20, 30 or 50 Amps, or more. The replacement plugs may be configured for 110, 220, 240 or more Volts.

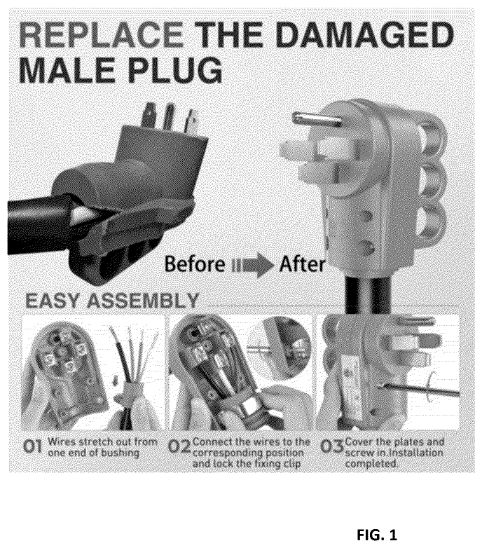

FIG. 1 illustrates replacement of a damaged plug, according to various embodiments of the invention.

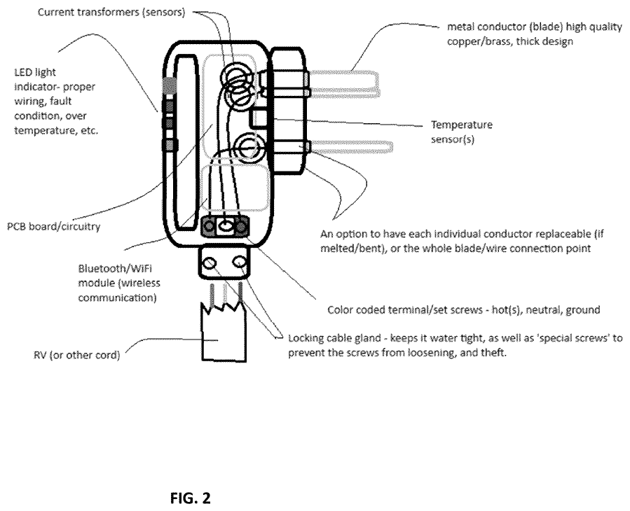

FIG. 2 illustrates an intelligent replacement plug (connector), according to various embodiments of the invention. The intelligent replacement plug/socket is optionally part of a powerline sensing system further including a computing system and/or a WiFi or wireless hotspot.

“PlugIN” replacement male or female ‘smart’ power end. PlugIN optionally stands for “Plug Intelligence”

Various embodiments of the invention include a powerline sensing system comprising: a replacement connector, e.g., male or female plug, or ‘(mid-line) pod’ plug configured to be attached to a power cable, the replacement plug comprising: The replacement powerline “connector or plug” can be any of these but not limited to a polarized plug, a grounded plug, a plug end, a hospital grade plug, a twist lock plug, a NEMA plug, a heavy duty plug, a power plug, replacement plug, or male plug. In addition, the powerline connector device, could reside in a female end version as well such as a replacement socket, female connector, receptacle, power socket, electrical outlet, twist lock socket, hospital grade receptacle, IEC socket, and a socket outlet. The ‘pod’ would be an enclosed section that houses all the necessary sensors, and has terminal block connectors for input and output. This allows a user to ‘cut’ their existing wire anywhere that is easily accessible, wire on a ‘pod’ and have the benefit of real time data, alerts, temperature monitoring and any other features as the male or female ends would.

The power line sensing system further includes a first sensor configured to generate a first analog output. The sensor may include, for example, a voltage sensor, such as but not limited to a Hall-Effect voltage sensor, resistive voltage sensor, capacitive voltage sensor. The design can also feature a digital output voltage sensor. The output of said sensor along with the CPU would determine the voltage on the line. Maintaining proper voltage is essential for many appliances to work right, and prevent premature failure.

The power line sensing system further includes an analog-to-digital converter configured to generate a digital representation of the first analog output.

The power line sensing system further includes an input/output configured to communicate the digital representation to a computing device. An embodiment is for the device to have a direct AC digital sensor. As there are both AC to analog and AC to digital ready sensors.

The power line sensing system optionally further comprises the computing device, wherein the computing device is configured to convey a status of the replacement plug to a user based on the digital representation.

The power line sensing system optionally further comprises a second sensor configured to generate a second analog output, the analog-to-digital converter optionally being configured to generate a digital representation of the second analog output.

Optionally, the first sensor is a current sensor; a voltage sensor; a temperature sensor; a light sensor; a tamper sensor, or a wattage sensor, a floating ground sensor, a polarity sensor, an open neutral sensor, a frequency sensor, a phase detector, and/or the like. For example, an AC voltage sensor, DC voltage sensor, Current sensors; Hall Effect sensor, shunt resistor sensor, Rogowski coil, Current Transformers; Single, dual, three phase, and split phase power sensors; active, reactive and apparent power and power factor sensors for single, split and three phase; energy sensors (watts, kilowatt hours), high low voltage (voltage), current/amps, temperature, ability (through sensors or programming) to detect reversed polarity, open ground, elevated voltage on ground, possibly and option as a GFCI (ground fault circuit interrupt), that measures the current going out and coming back. Resistance sensor, Capacitance sensor, Inductance sensor, Frequency sensor, Temperature sensors, temperature-compensated power sensors, radio frequency sensors, thermal power sensors, diode based power sensors, optical power sensors (such as photodiode or thermal sensors), Harmonic Analyzers, Phase Sequence sensors, Data logging sensors, Leakage current sensors, Magnetic Field Sensors, Insulation Resistance sensors, Oscilloscope Probe sensors, Power sensors, Differential voltage sensors (if you had a plugin on both male/female ends, to detect any loss of voltage/issue (or from point A to point B), Ground fault sensors, Circuit breaker sensors (ability to monitor the status and performance of the circuit breakers) Phase angle sensor, and optionally load sensors. Power over Ethernet (POE) sensors, and/or bi-directional power sensors.

Optionally the second sensor is a current sensor; a voltage sensor; a temperature sensor; a light sensor; a tamper sensor, a wattage sensor, and/or any of the other sensors discussed herein.

The power line sensing system optionally further comprises a relay configured to interrupt power passing through the replacement plug, the relay being operable from the computing device via the input/output. The sensing system may contain a relay or contactor that would be configured to interrupt power if a fault or other problem/condition is detected, or the user wishes to ‘shut down’ power to the connected RV/appliance. Certain versions of the replacement end or ‘pod’ can also serve as surge protectors, either with MOVs and traditional ‘sacrificial’ surge modules/components, and/or with a non-sacrificial type protector.

The non-sacrificial surge protector may include a version where it can shut down power, and a version(s) just like ‘base model’ surge protectors out there (IE computer surge protector) where it cannot disrupt power.

The power line sensing system optionally further comprises a sound generation device disposed within the replacement plug, the sound generation device being responsive to the digital representation or the first analog output.

The audible sound generation device (IE buzzer), can be turned off or on as desired. The buzzer would sound an alert if over temperature is detected, or other fault issues. This provides safety for nearby people or workers that a dangerous condition may be present. Overheating is one of the top issues at RV parks. Overheating AC plugs at homes is a very dangerous issue that is also prevalent. Having the PlugIn able to sound an alert is a huge benefit. Other power sensors do not have this function.

Optionally the power line sensing system is configured to detect mis-wiring of the replacement plug or a power source.

Optionally the replacement plug is configured to be attached to the power cable using a connector that requires a tool to remove. In some embodiments the connector is like a wheel lock There may be (optional) a special tool required to remove the connector for theft prevention. Similar to ‘locking wheel hubs for vehicles, or locking bolts for license plates. Possibilities include; tamper resistant screws, spanner screws (pin-in-torx), pentalobe, hexagon socket, tri wing, torq-set, tamper proof bolts, one way screws, clutch head bolts, security bolts or security nuts, breakaway bolts, locking bolts, and permanent options like rivets and security seals.

The connector may include a male or female replacement plug.

The replacement connector optionally incudes a plurality of male prongs or female receivers configured to conduct current, and the first or second senor are separable from the prongs or receivers of the replacement plug such that the prongs or receivers are replaceable without replacing the first or second sensor. This embodiment of the connector may be more like a replaceable male or female end, which has the added benefit of all the ‘smart’ stuff, but also in itself is a replacement male/female end/conductors. One option includes a swappable male/female conductors if they get damaged, versus replacing the whole connector.

The Input/output optionally includes both a digital input and a digital output or just a digital output.

The input/output is optionally configured to communicate the digital representation via a radio frequency signal (e.g., cellular, WiFi or Bluetooth), an ethernet connector, or a powerline modem.

The input/output optionally includes a powerline modem, the powerline modem optionally being configured to communicate data packets via the power cable or via a cable to a power source.

The connector of the power line sensing system may function as a Broadband over powerline (BPL) ‘node’, various embodiment may include a CoAx, or Ethernet port on it, or the PlugIN is itself ‘wireless’. So, the PlugIN sends its data to the user via wireless (BLE, WiFi, zigby, etc.). The non-sacrificial surge protector would have an option to have the BPL, with port options.

The computing device optionally includes a smartphone.

The input/output is further configured to act as a range extender for a wireless signal or is configured to provide a wireless (e.g., cellular, Bluetooth or WiFi) hotspot.

PlugIN and the non-sacrificial surge protector are ‘smart’ diagnostic tools. They enable the user to gain valuable information not only about the power supply, but their connected devices/equipment. They both would have the wireless connection ability (remote WiFi, BLE, etc.). They both can have the ability to detect a multitude of power issues (voltage, current, reversed polarity, open ground, ground voltage, GFCI, etc.) The non-sacrificial surge protector is in itself novel because ALL other surge protectors out there use MOVs and are finite. Eventually the surge protector and/or the module will need to be replaced. With the use of chokes, coils, capacitors, and other components, the non-sacrificial surge protector will be the last one that is needed. As an option(s) on that device, it has the BPL, CoAx or Ethernet ports, etc. (and list out the other feature). The PlugIN, is novel as all other outlet testers are temporary, meaning you have to plug it in, and then remove it. This is permanently attached. Plus most existing sensors do not do half of what this will do, nor are they wireless communicators, with the option for WiFi node, BPL, etc.

Some embodiments include a ‘pod’ (mid-line connector) that goes anywhere on the power line, and power line can be any household extension cable, a transmission line, an electric line, a utility line, a high voltage line, a grid line, feeder line, and/or any wire conductor. The ‘pod’ sensor can be on any other type of transmission line such as an ethernet cable, coax cable, phone line, RG-6, HDMI cables and so forth. The purpose of the ‘pod’ would be to convey detailed data to the user (such as but not limited to voltage, watts, power factor, amperage, and so on. For data and internet cables, the pod can detect bandwidth, frequency, download/upload speed, latency, pings, and other telemetry that can be useful for the user, or the sender of power or data to know.

In some embodiments, the invention comprises (but not limited to) male and female ends (pod) for a multitude of power cords. For example, a 15 A household extension cord end, either the male and/or the female end. The replacement end would be very similar to existing replacement ends, the consumer or end user would ‘add’ this male or female end to their existing cord (extension cords, RV power cords, hospital/industrial cords, marine, etc.) and it would be a simple process to use the cords existing wires, connect them to the male or female conductors and you have power. However, inside the end, houses sensors that can detect voltage, amperage, temperature, and so on, and can determine watts, kilowatt hours, power factor, wiring conditions (reversed polarity, open ground open neutral, etc.).

In some embodiments, the invention comprises a modular end. All existing replacement ends are ‘dumb’, they just simply allow the user to replace a burnt or melted or otherwise damaged end. They do not provide any ‘information or data’ on the power. Other plug in meters are temporary, meaning you plug the multimeter in, or outlet tester and then remove it to then connect your power cord. In this regard, they are manual, where you manually hold the testing probes in the outlet or power source, or remove the tester to the plug in your power cord. This invention solves that problem as it is a permanent fixture to the male or female end (possible option would be installed into the outlet/power source). The device would comprise different sensors that can detect voltage, amperage, watts, frequency, wiring issues, temperature, and so on. This data, is optionally sent to the user via a wireless connection to a website/cloud interface, and/or phone app. The user would get alerts of high or low voltage, wiring issues like open ground, or reversed polarity, and a multitude of other data. This allows the user to know exactly what is going on with the power they are getting, how many amps they are using, etc. Knowing how many amps you are using allows you to be proactive in limiting your amp draw to a lower amount than what the circuit/circuit breaker is rated for. This help prevent melting, damage, or fire as a result of over loaded circuits.

One option is to have a “pod” where the device has terminal blocks (set screw connections) on both ends and allows you to install this in the middle of any cable. There would be different options for different current (amp) levels, 120 and 240 V options, single phase, split phase, and three phase.

There can optionally be a temperature sensor in the end (male or female) housing. This would alert the user of high temperature, helping to prevent fires and damage to the cord, the outlet, or home. This can be a huge safety factor. Some embodiments are configured to analyze the power detected to use algorithms and other protocols or AI, to discern what loads are on, for example, a washing machine just turned on. With granular data from the watts, power factor, amp draw, voltage, temperature, etc. the user could be alerted to premature appliance failure.

An option is to have LED or other lights/indicators on the body of the male or female end, to show good power, wiring issue, bad power, over temperature, etc.

Various embodiments include units that only detect for volts, or watts, or amperage, or temperature. Or ones with all the features combined. 10 A, 15 A, 20 A, 30 A, 50 A versions, both male and female, marine and RV, household, industrial, medical, split phase, single phase, 3 phase, AC and DC power, etc. are all options. The device would be powered off of the incoming voltage, no battery or external power source would be needed.

An option is to have the male or female blades/conductors removed or replaced. Typically the male or female conductors are the part that fails with overheating and melts or becomes damaged. The end connections could be swapped out with new conductors and reuse the ‘sensors’ and other main parts.

Current sensor(s) for amperage detection, standard CT sensors, or Rogowski coils as an option, voltage sensors built into the PCB.

An option for the unit is if there is a fault(s) that it provides any or all a wireless alert, a visual alert, and or audible alert. For example, if it is detecting high temperature, it has audible beeps, and/or it sends a wireless alert (not limited to BLE, WiFi, NFC, Zigbe, RF, etc.), and/or indicator lights illuminate.

Most replacement ends are just that, a ‘dumb’ (provides no information, warning, etc.) male or female end. One (no longer sold) device had a pass-through sensor, but did not do as many things. However, a pass-through unit creates problems as you now have another ‘male and female’ end added to the circuit, which increases resistance, and the chance for it to come unplugged, have a bad connection, increases the weight on the outlet/connection, increases the chance of fire, etc. A unit like the invention replaces the existing male or female end with minimal weight increase. Pass-through sensors can easily be lost or stolen, having the device permanently attached to the end prevents this.

An optional feature includes ‘cost tracking’ where through the app or online/cloud site, you can see your kilowatt hour use and the estimated cost of power. RV parks or other places that charge for power, may use these as devices to base fees on. Typically, meters are installed in the house or building by electricians which cost a lot of money, this is a solution that is basically DIY

An optional feature includes a small relay inside the housing which can provide for remote power on/off. And/or if the unit detects an issue (high temperature, low voltage, reversed polarity, etc.), the unit may be configured to shut down power protecting the connected devices/appliances.

The replacement plug is optionally comprised of heat-resistant plastics or resins (as an option), thicker metal conductors, a ‘hot swap’ option where the male and/or female conductors can be swapped out.

Many problems RVers face is a lack of a device that has the ability to measure voltage supplied, amperage used by the RV, Watts and Kilowatt Hours of power use, ability to detect for heat/melting ends and send an alert wirelessly as well as audible and light warning. It is a universal male end pug replacement not limited to 30 A and 50 A for RVs, but potentially for EVs, and standard 110 outlet cords.

Various embodiments include a device that is a ‘replacement’ male plug. The RVer would cut off their existing plug end, splice back the wire jackets and then wire them into the appropriate color coded terminals of the PlugIN (connector). This is a simple end user installation process, with color coded connections for safety and simplicity. The plug would replace their existing male plug and thus it is an OEM replacement. To secure the smart PlugIN to the RV (or other) cord, special screws/bolts would be provided, like a security lock for wheel lugs, not a simple flat or Philips head.

In various embodiments the male blades that stick out of the end may be replaceable as well. They would have their own set screw for connection/replacement. Melted ends (male and female) are one of the number one issues RVers face. So rather than replace the whole end if a conductor melts, you can replace that single conductor (hot(s), ground, or neutral).

The PlugIN smart plug optionally has the ability to detect for mis wired pedestals (open ground, open neutral, no power, reversed polarity, etc.). They could indicate (option) a fault by visual and/or audible alerts, visual lights on the plug itself. As well as the ability to alert the user via WiFi or Bluetooth, or other wireless methods.

The PlugIN may have a thermal sensor (or more) to detect for a melting/hot conductor. The thermal sensor may alert the user via wireless communication to an app and/or user cloud profile. The PlugIN may also have the option for red/flashing lights on the plug face, as well as an audible alert. Many times, RV plugs melt, no one is there and the RVer is usually unaware as melted ends take time to develop. With an audible alert, it may potentially save lives and infrastructure by alerting people in the area (and wireless alert) about a dangerous overheating condition.

By having the PlugIN as a replacement male plug, it removes the need for a pass-through device (you plug in your cord, to a ‘smart’ device, which plugs into the power source. These older style devices would often come out, as there is too much weight and pull down on the end that is extended out. This novel design of a replacement end, means that the original dimensions of the cord plug are kept the same ensuring a good tight fit that is less likely to slip out, have a loose connection and melt. Currently replacement male/female ends are linear. With heavier 30 A or 50 A RV cords, it is a benefit to have the wire come down at a 90 degree angle and stay as close to the pedestal plug/connection as possible.

The app may have the ability to connect via WiFi and/or Bluetooth (or other wireless technology). The app would receive alerts, set alert thresholds for volts and amps and KWH, relay real time data (volts, watts, amps, frequency, KWH, open ground, open neutral, reversed polarity, temperature, etc.). The unit/app may keep track of KWH use with a resettable time stamp. The unit may have the ability to connect to Alexa or other smart assistants, and the user could ask “what is my voltage, alert me if the voltage hits 108 V AC, etc.).

Because the PlugIN will have both WiFi and Bluetooth, it can possibly act as a WiFi range extender for the users WiFi (or camp WiFi) as a mesh node.

A possibility is for this PlugIN unit to establish a ground reference point since it will be connected to the power source neutral and ground. External sensors could be placed on the metal parts of an RV and detect for the presence of stray voltage/hot skin.

The PlugIN, is optionally sold as a male plug, or a female plug version, bladed and twist lock options for all power sources (15 A, 20 A, 30 A, 50 A, etc.)

The PlugIN may comprise an appropriate thermal protected plastic or glass nylon body, current sensors to measure amperage, a PCB to measure voltage, WiFi and Bluetooth modules, LED indicator lights, terminal connections and set screws. The male blades can be replaceable.

The male or female end or ‘pod’ has a connection port for ethernet, coax, USB, or any other interface. This could offer surge protection if the version has surge protection. It could also be an ‘entry’ point, for example, ethernet that provides WiFi to the unit or connects it over the power line.
Option for the ‘pods’ and cord ends to have surge protection, either standard SPD or non-sacrificial surge protection.
Different ends, both male and female, different NEMA connections, 15 A, 20 A, 30 A, 50 A, etc.
Option for having a GFCI (ground fault circuit interrupt) function either in the end(s) or ‘pod’
Versions with and without LED indicator lights on the body, and/or LCD display
Versions with or without audible buzzer/alert
Versions with or without Bluetooth or wireless communication
Versions with or without tamper alerts—the unit will be detecting various parameters (voltage, current, etc. and as such, it could determine if a wire is cut. Likewise, if a user has a smart connector at each end of the wire, the user could determine if the wire is cut or damaged/tampered with.
Versions that can diagnose power issues—bad ground, bad neutral, high/low voltage.
Versions that work as a node, or repeater for wireless communication (of the device, and/or generic WiFi or other signal repeaters) or as a node in a mesh type network.
Versions that act as WiFi routers/repeaters with Internet over powerline or the like.
Versions with or without temperature sensors
Versions with or without the ability to disconnect power (using relays or contactors or shunts).
Versions with or without power management ability, to turn off the power if there is a fault or issue detected, or turn off the power by choice, schedule or timer. (Timer function, scheduling)
Waterproof and weather resistant versions (some applications might be underwater/wet environments).
Versions with or without “SENSE” function—ability to get very detailed data parameters of power use. Such as seeing the ‘in rush’ current of appliances, power factor, high/low voltage points, current draw of specific loads, etc that can help determine premature failure in connected appliances/loads.
Optional remote display (wireless communication to cord end or ‘pod’) and/or phone/device ‘app’
Versions with or without ‘hot swap’ ends. The male or female metal conductors can be swapped out in the field, replacing the part that goes bad, not the whole device.
Version with the combined 30 A/50 A receptacle connector.

Versions that are non-destructive to the wire, and just snap on/over the wire
Versions of the unit to MODIFY then. For example, the cord end or ‘pod’ will have a PCB board, but open spots, to add different sensors, for the DIY person, or client with specific testing/measuring needs. For example, the addition of a buzzer, or temperature sensor, WiFi module, etc., by simply plugging in/clipping in any sensor that is needed in a modular fashion. An embodiment could be a kit or parts that are added as needed.
Versions with gas discharge tubes and other components for lightning protection.
Versions with and without capacitors or other components to aid in power factor correction. Capacitors in parallel with the load, and/or variable frequency drives (VFD) can aid in power factor correction. This could be integrated into the design.
The app/dashboard would have the ability to enter costs per kWh for users to see specific, real-time costs for electricity based on their rates.
Versions could contain a ‘soft start’ ability—a module or component that softens the hard start (in rush current) for motors and compressors. Usually, this feature draws out or lengthens the start-up amperage time, but lowers the overall in rush current peak (level of amps).
Versions of the end connectors could reside in actual receptacles or junction boxes versus on the cord ends.

Another option for the surge protector is the inclusion of a satellite receiver/module. Most current units only have Bluetooth, and some have WiFi. But with satellite, you only need a decently clear shot at the sky. Data packets for issues (faults) are low data, so this might not be the real time data, but only in emergencies (faults detected, too hot/melt detection, etc.) would be transmitted via Satellite.

It would be an expensive option, but you could have satellite also as the source/mode for internet. So satellites would provide the internet, the surge protector would be the WiFi router/hub.

Another optional feature would be a port or connection point for a grounding rod. As mentioned, this would increase the protection from lightning coming from the RV park power side. If lightning strikes ‘upstream’ from your RV, it can flow through the power lines that are feeding your RV. Ground is not bonded to neutral in RVs (per code), only at the main transformer for the RV park. Adding a grounding rod at the pedestal via attachment to the surge protector, you are giving lightning a path to ‘earth ground’. It has a high probability of saving or help protecting your RV.

A separate item could be the MoCA adapters that are weatherproof for the RV site(s).

The park can get internet into the park from a internet provider, then they can transmit WiFi to the surge protector (OR PlugIn or ‘pod’) which has WiFi/wireless, can act as an extender, or mesh node. The park can transmit WiFi to BPL adapters throughout the park, and the surge protector can ‘read’ this and transmit WiFi, as well as be hardwire connected via BPL or MoCA.

Currently, no RV surge protectors have a STM card (cell service), this is an option to transmit the surge protector's data (volts, watts, amps, frequency, faults, etc to the end user).

It should be possible to send the BPL signal through the ground conductor. There might be less interference than the hot(s) or neutral wire, as ground is only really for emergency and there should not be voltage/current on it.

He has some new ideas. Several embodiments are specifically illustrated and/or described herein. However, it will be appreciated that modifications and variations are covered by the above teachings and within the scope of the appended claims without departing from the spirit and intended scope thereof. For example, the described system may be used for other that recreational vehicles, e.g., for electric vehicle charging cables or for (power or communication) cables connecting medical devices. While “RVs” are discussed herein. The power sources and other features discussed herein are not limited to RVs and may be configured for other types of vehicles, e.g., for charging electric or hybrid vehicles. For example, an electric vehicle charging station may provide both power and an internet connection while charging.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

The “logic” discussed herein is explicitly defined to include hardware, firmware or software stored on a non-transient computer readable medium, or any combinations thereof. This logic may be implemented in a quantum, electronic and/or digital device (e.g., a circuit) to produce a special purpose computing system. Any of the systems discussed herein optionally include a microprocessor, including quantum, electronic and/or optical circuits, configured to execute any combination of the logic discussed herein. The methods discussed herein optionally include execution of the logic by said microprocessor.

1. A surge protector comprising:
a voltage input configured to be connected to an AC or DC power source and to receive an input voltage from the power source;
a voltage output configured to be connected to a vehicle and to provide an output voltage to the vehicle;
a voltage surge protection circuit configured to prevent voltages above a desired threshold from appearing at the voltage output, the voltage surge protection circuit being non-sacrificial; and
a reset circuit configured two reset the voltage surge protection circuit following appearance of a voltage above the desired threshold at the voltage input.

2. A connection system for providing both AC power outlets and internet connections, the system comprising:
an AC power input configured to receive AC power from a power source;
a first AC power output;
a second AC power output, the first AC power output and the second AC power output each separately including a filter configured to prevent output voltages above a desired voltage;
electrical connectors configured to convey the AC power between the AC power input and the first and second AC power outputs;
an internet connector configured to establish external internet connections from the connection system to the internet;
a first local internet connector configured to provide a first internet connection (access point) via the external internet connector, wherein the first local internet connector is co-located with the first AC power output;
a second local internet connector configured to provide a second internet connection via the external internet connector, wherein the second local internet connector is co-located with the second AC power output; and
control logic configured to configure the first and second local internet connectors;
wherein the first and second AC power outputs are members of a set of at least 6 power outputs, each of the 6 power outputs being co-located with a separate local internet connector.

3. The system of claim 2, wherein the local internet connectors each separately includes a WiFi, Bluetooth or other wireless internet connection, such as Zigbee, IEEE 802.11Ah, Z-wave.

4. The system of claim 2, wherein at least one of the local internet connectors includes an Ethernet connector.

5. The system of claim 2, wherein at least one of the local internet connector is configured to communicate digital data over the electrical connectors such that data and power are provided over the same electrical connectors.

6. The system of claim 2, wherein the control logic is configured to assign different passwords to each of the local internet connectors.

7. The system of claim 2, wherein the control logic is configured to automatically generate different passwords and/or network names for each of the local internet connectors.

8. The system of claim 2, wherein the control logic is configured to reset each of the filters, is configured to reset each of the filters, and/or is configured to determine a status of each of the filters.

9. The system of claim 2, further including one or more voltage sensors configured to detect a floating ground, wherein the control logic is configured to turn off power to one or more of the AC power outputs associated with the floating ground.

10. A powerline sensing system comprising:
a power connector configured to be attached to a power cable, the power connector comprising:
a first sensor configured to generate a first analog output,
an analog-to-digital converter configured to generate a digital representation of the first analog output, and
an input/output configured to communicate the digital representation to a computing device.

11. The powerline sensing system of claim 10, further including a second sensor configured to generate a second analog output, the analog-to-digital converter optionally being configured to generate a digital representation of the second analog output.

12. The powerline sensing system of claim 10, wherein the first sensor and second sensor include: a current sensor; a voltage sensor; a temperature sensor; a light sensor; a tamper sensor, an open ground sensor, an elevated voltage on ground sensor, or a GFCI (ground fault circuit interrupt) sensor.

13. The powerline sensing system of claim 10, wherein the powerline sensor is configured to detect mis-wiring of the replacement plug or a power source.

14. The powerline sensing system of claim 10, wherein the input/output is configured to communicate the digital representation via a radio frequency signal (e.g., cellular, wifi or Bluetooth), an ethernet connector, or a powerline modem.

15. The powerline sensing system of claim 10, wherein the input/output includes a powerline modem, the powerline modem optionally being configured to communicate data packets via the power cable or via a cable to a power source.

16. The powerline sensing system of claim 10, wherein the input/output is configured to provide a wireless hotspot.
